(19) United States
(12) Patent Application Publication
(10) Pub. No.: US 2025/0061221 A1
(43) Pub. Date: Feb. 20, 2025

(54) LOCK SYSTEM FOR TASK COMPLETION MODULE

(71) Applicant: Krista Monk, Tulsa, OK (US)

(72) Inventor: Krista Monk, Tulsa, OK (US)

(21) Appl. No.: 18/807,662

(22) Filed: Aug. 16, 2024

Related U.S. Application Data
(60) Provisional application No. 63/533,072, filed on Aug. 16, 2023.

(51) Int. Cl. G06F 21/62

(52) U.S. Cl. CPC G06F 21/6218

(57) ABSTRACT

A system for completing tasks and providing notifications includes a lock system. The lock system restricts, prohibits, or otherwise impedes access to applications on a user's personal computing device during a lockdown period associated with the tasks or notifications. The lock system ends the lockdown period when the user completes the task or acknowledges the notification.

### RELATED APPLICATIONS AND INCORPORATION BY REFERENCE

This application claims priority to U.S. Provisional Patent Application No. 63/533,072, filed on Aug. 16, 2023, the entire content and disclosure of which is incorporated by reference in its entirety.

### FIELD OF THE INVENTION

The present disclosure relates to systems and methods for a task completion module, and more particularly, to lock systems for a task completion module.

### BACKGROUND

Facilities such as teaching institutions, government agencies, healthcare facilities, and companies have many individuals who receive or manage services and require updated information and access to tasks. For example, teaching institutions, such as elementary schools, middle schools, high schools and beyond typically offer educational offerings to hundreds, if not thousands, of students in a normal school year. As the education system moves into a hybrid of traditional schooling (e.g., in-person) and non-traditional schooling (e.g., on-line), the ability to monitor and provide alerts to students of time sensitive items proves to be a difficult task. In addition, it may be difficult to monitor and motivate people to complete tasks assigned by supervisors.

Modern day solutions typically involve implementing technology to automate tasks or provide access to users. However, current systems may not provide notifications or information to appropriate people (e.g., systems are over inclusive or underinclusive for who receives notifications and access). In addition, users may be distracted by other applications on a computing device and/or may not be appropriately motivated to complete a task within a reasonable time.

### SUMMARY

One aspect includes a task completion computing device which includes a processor in communication with a memory. The task completion computing device is programmed to receive an assigned task from an administrator or supervisor account; display the assigned task on a computing device associated with a user receiving the task; instruct the user to complete the task within a preset timeframe; initiate a restricted access period when the task completion computing device receives the assigned task; restrict access to applications on the computing device during the restricted access period, where the restricted applications include games, social media, and internet applications; receive inputs from the user relating to completion of the task; generate a request for a supervisor account to approve completion of the task; and end the restricted access period and restore access to the applications on the computing device if the supervisor account approves completion of the task.

Another aspect includes a notification computing device. The notification computing device is programmed to receive enrollment data pertaining to a user; associate one or more users of the notification computing platform based on the enrollment data; associate an institution with the user based on the enrollment data; receive, on an ongoing basis, information from the institution; detect an actionable item based on the information received from an administrator, a supervisor, or the users; generate an alert based on the actionable item; and transmit the one or more users associated with the institution.

Another aspect includes a method for completing tasks and providing notifications implemented by at least one processor in communication with at least one memory. The method also includes receiving an assigned task from an administrator or supervisor account; displaying the assigned task on a computing device associated with a user receiving the task; instructing the user to complete the task within a preset timeframe; initiating a restricted access period when the task completion computing device receives the assigned task; restricting access to applications on the computing device during the restricted access period, where the restricted applications include games, social media, and internet applications; receiving inputs from the user relating to completion of the task; generating a request for a supervisor account to approve completion of the task; and ending the restricted access period and restoring access to the applications on the computing device when the supervisor account approves completion of the task.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example computing system.

FIG. 2 illustrates a client computing device that may be used with the computing system illustrated in FIG. 1.

FIG. 3 illustrates a server system that may be used with the computing system illustrated in FIG. 1.

FIG. 4 illustrates a method for the implementation of a notification service by the notification computing system illustrated in FIG. 1.

FIG. 5A illustrates a flow diagram of an example task management system.

FIG. 5B illustrates additional detail of the flow diagram of the example task management system of FIG. 5A.

FIG. 6 illustrates a flow diagram of an example lock system for a user computing device of the task management system illustrated in FIGS. 5A and 5B.

FIGS. 7A-7C illustrate a spreadsheet of modules and capabilities for the task management system illustrated in FIGS. 5A and 5B.

FIG. 8 illustrates a diagram of user profiles listed in FIGS. 7A-7C.

FIG. 9 illustrates a wire diagram of a module for sending notifications and completing tasks.

FIG. 10 illustrates an flowchart of an example method for sending notifications and completing tasks.

FIG. 11 illustrates an example dashboard user interface of a system and method for sending notifications and completing tasks.

FIG. 12 illustrates an example user interface of a system and method for sending notifications and completing tasks showing an administrator view.

FIG. 13 illustrates an example user interface of a system and method for sending notifications and completing tasks showing an assignment view.

FIG. 14 illustrates an example user interface of a system and method for sending notifications and completing tasks showing an assignment start display.

FIG. 15 illustrates an example user interface of a system and method for sending notifications and completing tasks.

FIG. 16 illustrates an example user interface of a system and method for sending notifications and completing tasks showing a login screen.

FIG. 17 illustrates an example of user interface including an assignment to be completed by a user.

Unless otherwise indicated, the drawings provided herein are meant to illustrate features of embodiments of the disclosure. These features are believed to be applicable in a wide variety of systems including one or more embodiments of the disclosure. As such, the drawings are not meant to include all conventional features known by those of ordinary skill in the art to be required for the practice of the embodiments disclosed herein.

### DETAILED DESCRIPTION

The present embodiments may relate to, inter alia, systems and methods for providing a notification and alert service. In one example, the systems and methods may be performed by an Education-Based Notification (EBN) computing device. In the example, the Notification computing device may be in communication with one or more of a plurality of user computing devices, a plurality of server computing devices, or a combination thereof. In one example, the process may be performed by an education-based notification computing device.

Recent changes to education, academia, work, and parenting as a result of events such as increasing globalization and pandemics heavily emphasize an increasing need for remote work capability. For example, it is desirable that students be monitored with the same level of scrutiny when taking an exam remotely as they would be were they in a physical classroom. Parents may have a more difficult time monitoring a child's usage of the multitude of online applications and products and ensuring a child is meeting standards, such as timely completion of chores and academic tasks.

The present systems and methods aim to improve monitoring, detection, and management of users in a multitude of capacities, for example, improving virtual test-taking environments for students to ensure fairness and improving management of children's online activity by parents.

### Example System for a Notification and/or Task Management Service

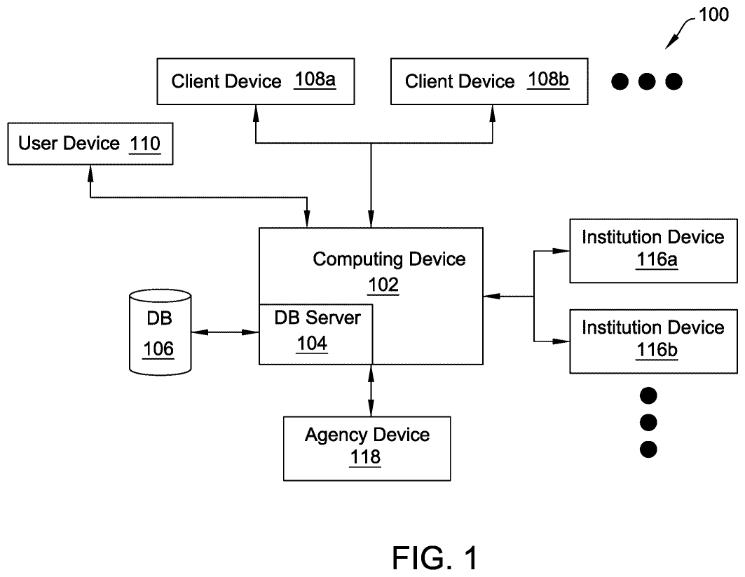

FIG. 1 depicts a computing system 100 for providing notifications, e.g., emergency notifications, subscription services notifications, Education-Based Notifications (EBN), membership notifications, and/or any other types of notifications, and/or completing tasks or assignments. Computing system 100 includes a computing device 102. Computing device 102 may include a database server 104 and may be in communication with, for example, a database 106, one or more client devices 108a and 108b, and a user device 110. Devices 108a, 108b, and 110 may be, for example, mobile devices, tablet PCs, portable computers, or the like. In some embodiments, computing device 102 may be associated with, for example, an administrator associated with, for example, user device 110. In some embodiments, computing device 102 may be part of one of the client devices 110a, 110b, or part of user device 110.

The systems and methods described herein may additionally or alternatively include the detecting of actionable alert items with information data streams received from data providers. For example, an education institution information stream may contain data pertaining to, but not limited to, school events, school closures, rescheduling of classes/events, emergency broadcast, absentee alert, or the like. Database 104 may be implemented as a local storage option. Alternatively, database 104 may be a remote storage location, such as a cloud storage option. Based on a profile of a user, certain data items may be considered relevant and cause, or trigger, an alert to notify appropriate persons (e.g., the student, student's guardian, etc.).

Client devices 108a, 108b, and user device 110 may be computing devices that include a user interface such as a web browser or a software application, which enables client devices 108a and 108b to access remote computer devices, such as computing device 102, using the Internet or other network. More specifically, client devices 108a and 108b may be communicatively coupled to computing device 102 through many interfaces including, but not limited to, at least one of a network such as a local area network (LAN), a wide area network (WAN) such as the Internet, or an integrated services digital network (ISDN), a dial-up-connection, a digital subscriber line (DSL), a cellular phone connection, and a cable modem. Client devices 108a and 108b may be any device capable of accessing a network and/or communicating with other devices including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Further, in the example, client devices 108a and 108b may include additional features, including, but not limited to, sensors, a GPS, an accelerometer, a gyroscope, or the like. Computing device 102 may retrieve data, such as location-based data or other sensor-derived data, from the database 106 and use the data to generate or transmit notifications and/or alerts. Computing device 102 may use profiles created for user devices 108a and 108b to regulate and determine appropriate notifications and alerts. The profiles may be stored in the database, in a memory of computing device 102, and/or on user devices 108a and 108b.

Institution devices 116a and 116b may be computers that include a user interface such as a web browser or a software application, which enables institutions devices 116a and 116b to access remote computer devices, such as Computing device 102, using the Internet or other network. In some embodiments, institution devices 116a and 116b may be associated with, or part of a computer network associated with, institutions like government agencies, emergency services, subscription companies, K-12 schools, universities, community colleges, etc., or in communication with the institution's computer network (not shown). In other embodiments, institution devices 116a and 116b may be associated with a third party and are merely in communication with the institution's computer network. That is, institution devices 116a and 116b may be associated with the institution's associated users. More specifically, institution devices 116a and 116b may be communicatively coupled to the Internet through many interfaces including, but not limited to, at least one of a network such as a local area network (LAN), a wide area network (WAN) such as the Internet, or an integrated services digital network (ISDN), a dial-up-connection, a digital subscriber line (DSL), a cellular phone connection, and a cable modem. Institution devices 116a and 116b may be any device capable of accessing a network and/or communicating with other devices including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Agency device 118 may be a computer that includes a user interface such as a web browser or a software application, which enables agency device 118 to access remote computer devices, such as computing device 102, using the Internet or other network. In some embodiments, client device may be associated with, or part of a computer network associated with, a broadcast alert system, or in communication with the agency's computer network (not shown). In other embodiments, agency device 118 may be associated with a third party and is merely in communication with the agency's computer network. More specifically, agency device 118 may be communicatively coupled to the Internet through many interfaces including, but not limited to, at least one of a network such as a local area network (LAN), a wide area network (WAN) such as the Internet, or an integrated services digital network (ISDN), a dial-up-connection, a digital subscriber line (DSL), a cellular phone connection, and a cable modem. Agency device 118 may be any device capable of accessing a network and/or communicating with other devices including, but not limited to, a desktop computer, a laptop computer, a personal digital assistant (PDA), a cellular phone, a smartphone, a tablet, a phablet, wearable electronics, smart watch, or other web-based connectable equipment or mobile devices

Database server 104 may be communicatively coupled to database 106 that stores data. In one embodiment, database 106 may include user data associated with users (e.g., demographics and location data), telematics data of the users, profile data of the users, private or personal data, third party data (e.g., relating to user data and public data from third parties), etc. In the example, database 106 may be external to and/or at least partly included on computing device 102. In some embodiments, database 106 may be decentralized. In the example, a user may access database 106 and/or Computing device 102 via user devices 108a and 108b.

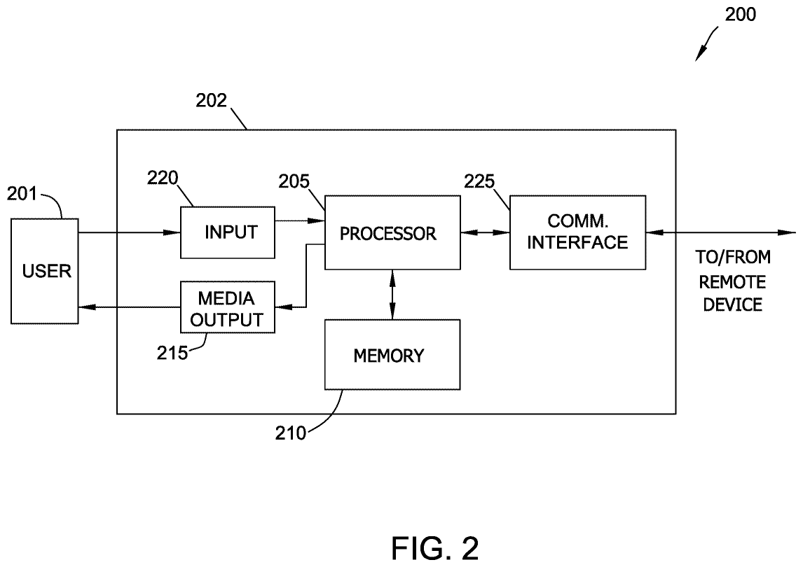

FIG. 2 illustrates a diagram 200 of a computing device 202, such as the Computing device 102 shown in FIG. 1. Computing device 202 may include, but is not limited to, a processor 205, a memory 210, a media output component 215, an input device 220, and a communications interface 225. Other embodiments may include different or additional components shown in FIG. 2.

In examples, processor 205 may include and/or be communicatively coupled to one or more modules for implementing the systems and methods described herein. For example, in one example, a module may be provided for receiving user enrollment data and building a user profile based upon the received user enrollment data. Received data may include, but is not limited to, demographic data pertaining to a user, such as a student, including student's age, sex, grade, school enrollment data, grade history, or the like. Additional student information may include phone number, address, siblings, legal guardian data, or the like.

In one or more examples, computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display a status of the model and/or display a prompt for user 201 to input user data. In another embodiment, media output component 215 may be configured to, for example, display a notification alert transmitted by Computing device 102.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), a gyroscope, an accelerometer, a position detector or an audio input device. A single component, such as a touch screen, may function as both an output device of media output component 215 and an input device of input device 220.

Client computing device 202 may also include a communication interface 225, which can be communicatively coupled to a remote device, such as computing device 102, shown in FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are examples only, and are thus not limiting as to the types of memory usable for storage of a computer program.

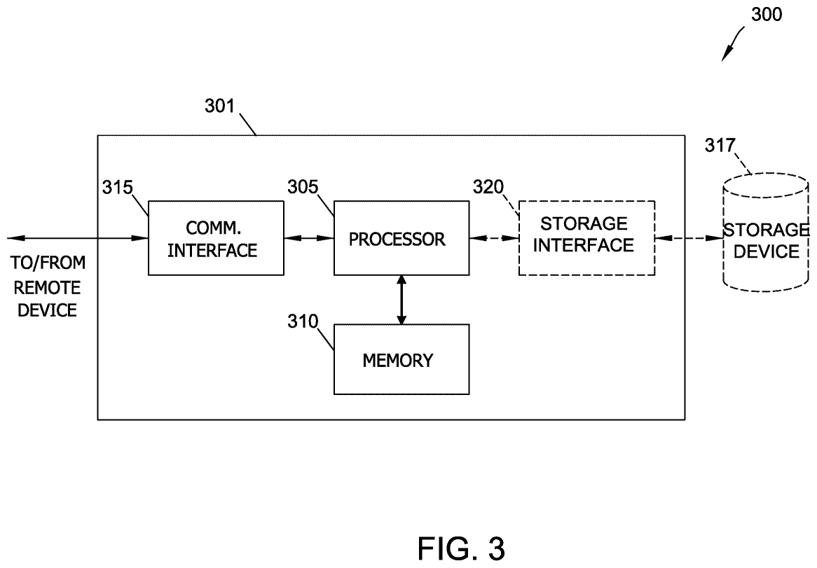

FIG. 3 depicts a block diagram 300 showing a server system 301 that may be used with computing system 100 illustrated in FIG. 1. Server system 301 may be, for example, computing device 102 and/or database server 104 (shown in FIG. 1).

In examples, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with computing device 102, user devices 108, institution devices 116, agency device 118 (all shown in FIG. 1), and/or another server system. For example, communication interface 315 may receive data from user devices 108a and 108b via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer system.

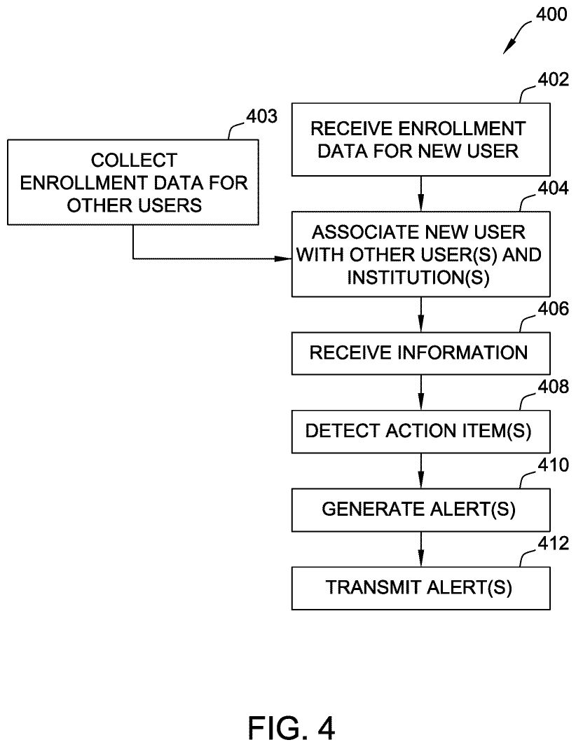

FIG. 4 depicts a method 400 for generating and transmitting alerts by an education-based notification (EBN) system. Method 400 may be performed by computing device 102 (shown in FIG. 1). User enrollment data, private information, third-party data, transmitted notifications, etc., may be stored within a storage device associated with computing device 102, such as database 106, for subsequent retrieval.

Method 400 includes receiving 402 user enrollment data (e.g., demographics and/or location data, education information, family data) for a new user. Method 400 also includes collecting 403 user enrollment data of other users. For example, user enrollment data may be collected when each user enrolls in the system, when the system updates, and/or when the system receives a search request for user enrollment data. User enrollment data, in some embodiments, may be from users themselves, private or public data sources sending on behalf of the user, from someone associated with the user, or a combination thereof.

In addition, method 400 includes associating 404 the new user with other users of the system. Association 404 of the user with other system users may be performed to ensure that only users who may take an interest in alerts generated for the new user receive the alerts. For example, a parent or legal guardian typically wants to stay informed regarding their child's school events or other important broadcast messages, such as a fire alarm or school closing event due to inclement weather. Additionally, or alternatively, a student may be associated with a certain school, such as their elementary school, or middle school, based on information provided at enrollment. The association of users ensures that the user only receives relevant information. For example, a student is only notified or only receives alerts from the school they are attending. An additional verification step may be provided by the EBN service, such as an authorization that the student is indeed enrolled with an indicated school, for example. For example, the verification step includes retrieving and/or requesting authenticated enrollment information from the institution.

Method 400 further includes receiving 406 information from one or more schools enrolled with the computing device 102. For example, an educational institution may routinely transmit messages to the computing device 102 including school events, closures, or the like. Method 400 includes detecting 408 events or action items that should be transmitted to certain users, based on the user's enrollment data. Also, method 400 includes generating 410 and transmitting 412 alerts to appropriate parties based on the user enrollment data. For example, if an alert or event data is submitted to the computing device and detected to be of relevance to a certain user, the generated alert may then be transmitted to the user along appropriate channels (e.g., email or text alert) as well as to any users that are also associated with the user (e.g., their parents or legal guardian(s)) along appropriate channels (e.g., email or text alert). Alerts and notifications may be fully user-configurable. For example, a user may opt to only receive information pertaining to certain events (e.g., sports schedules, band events) or to only receive by certain channels (e.g., email only, text only, etc.).

The method 400 may include additional, less, or alternate actions, including those discussed elsewhere herein.

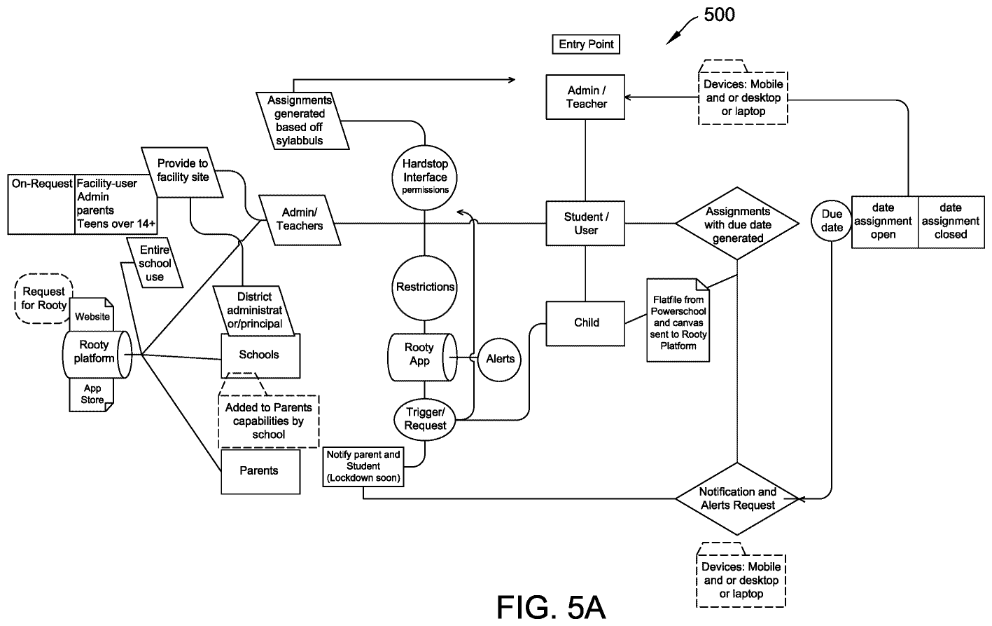

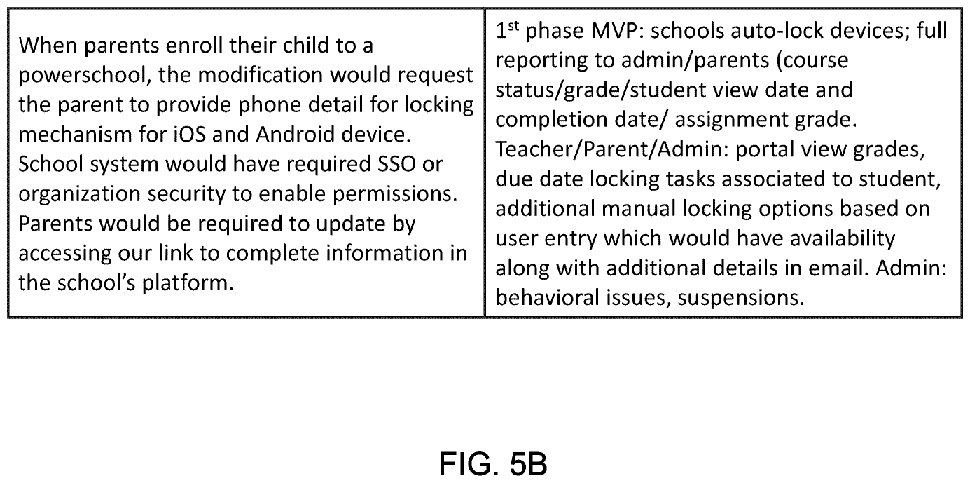

FIGS. 5A and 5B illustrate a flow diagram of an example task management system 500. In the example, task management system 500 is used for an education institution for managing assignments provided by teachers to students. In other examples, task management system 500 (and any systems or methods described herein) is used for any institution requiring record keeping and/or task management.

Task management system 500 includes Admin/Teacher modules, a Schools module, a Parents module, and a Student/user and/or Child module. Admin/Teachers modules, Schools modules, and user modules (e.g., Parents modules and student/child modules) are used by people to enroll in and/or activate the service. Parent modules may be used by parents to enroll for the students by providing enrollment information and creating accounts. A student account is associated with a parent or guardian account. Each parent or guardian account may be associated with more than one student account.

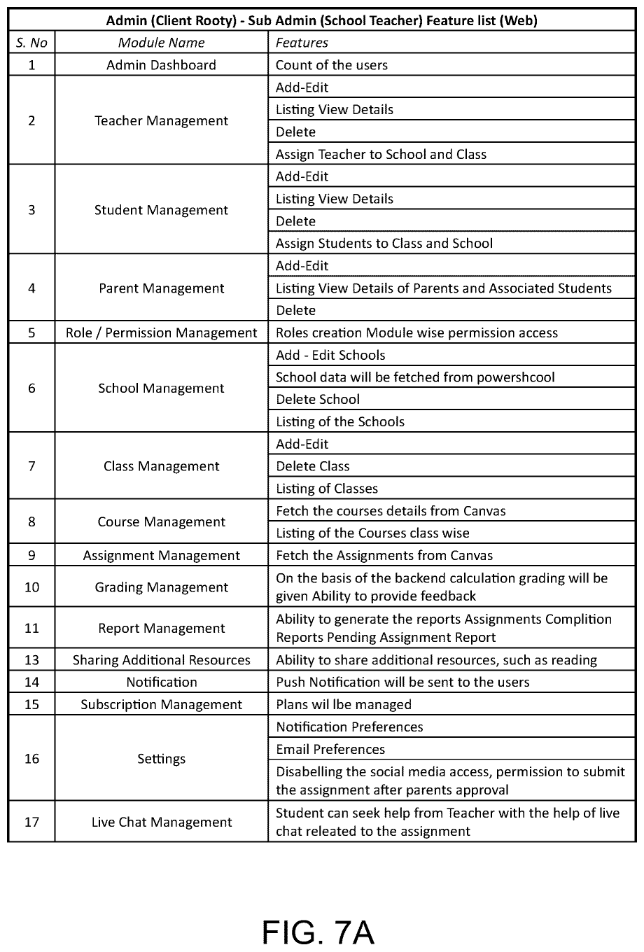

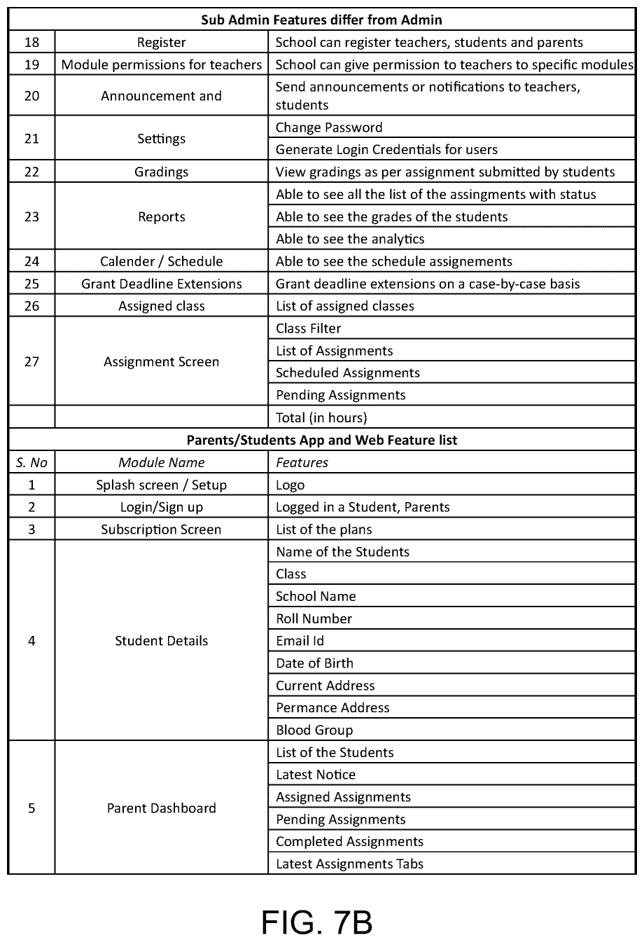

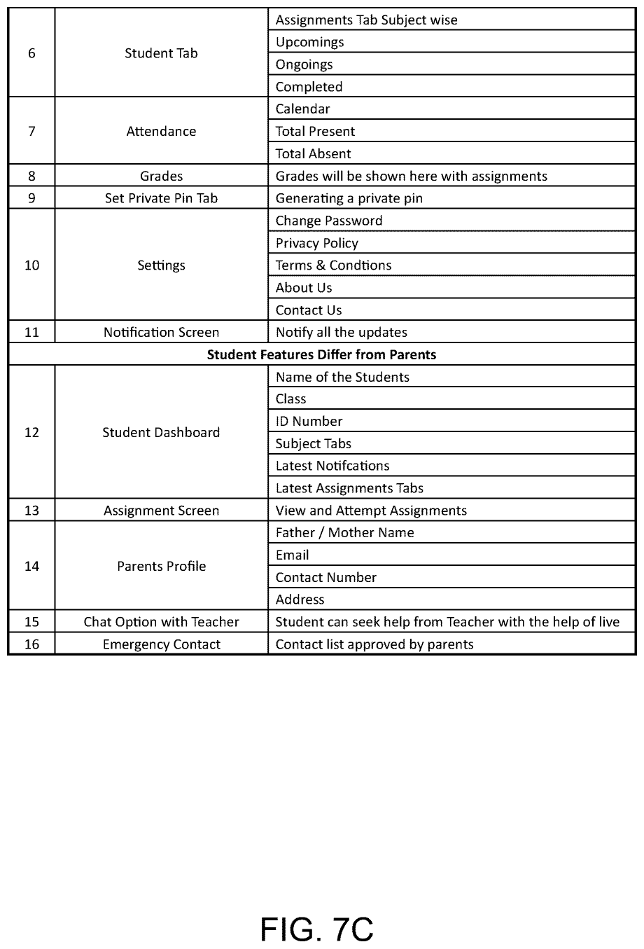

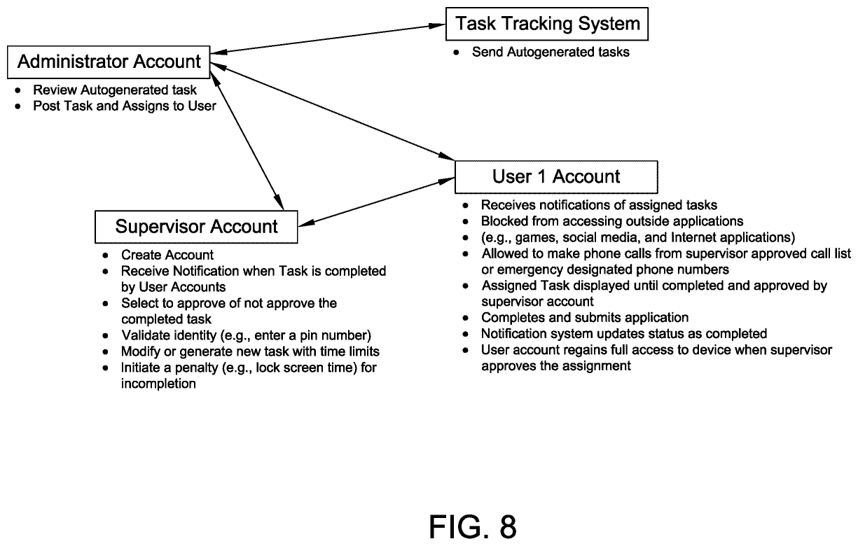

System 500 may have any suitable modules and user profiles or accounts. FIGS. 7A-7C illustrate a spreadsheet of example modules and capabilities for the task management system illustrated in FIGS. 5A and 5B. FIG. 8 illustrates a diagram of the user profiles listed in FIGS. 7A-7C. In embodiments used for institutions other than education institutions, for example, the Admin/Teachers modules are Admin modules, the parent modules are supervisor modules, and the student/child modules are user modules. Each module may be associated with one or more profiles or accounts such as admin accounts, supervisor accounts, and user accounts. The admin accounts and supervisor accounts, for example, may be combined in one or more dual purpose accounts which have multiple permissions. For example, in a home education setup, a user account may have permissions that allow an individual to act as both a teacher generating and reviewing assignments and a parent supervising a student account.

In the example, task management system 500 has a child account which provides different capabilities and/or operating systems than a student/user account. For example, the child account may be provided for a child that is older than 13 years old and that needs to provide different locking protocols for an associated parent account. In addition or alternatively, the child account may be used for a child that is not directly associated with an institution account but still wishes to utilize the system. The child account (or any other account) may allow a user to customize account settings and/or security preferences on an operating system of a computing device.

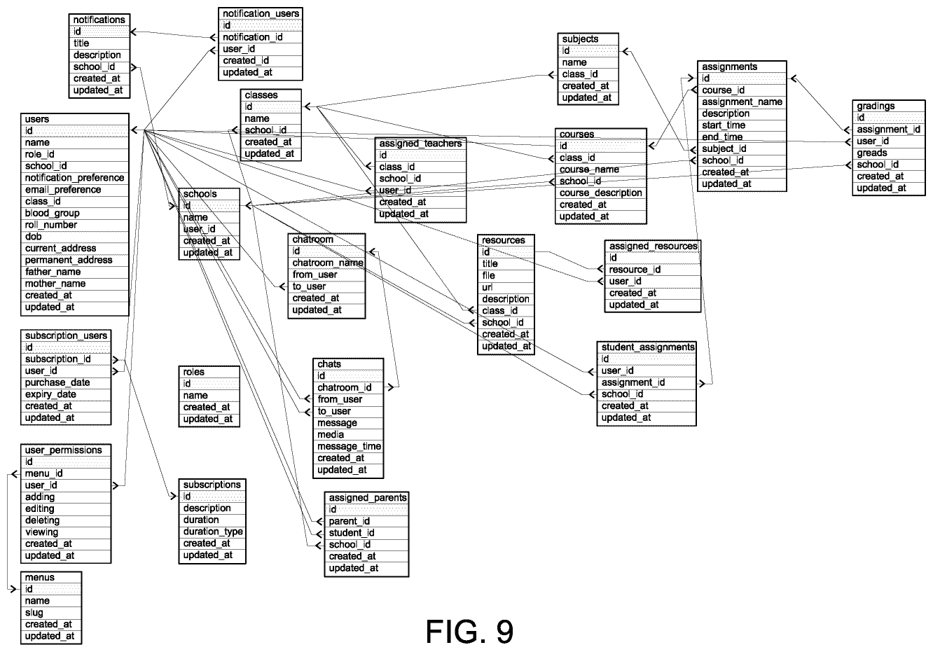

The admin/teachers, schools, and/or parent accounts may register with a service and download the application to designated computing devices. For example, the parent account and/or an admin account may subscribe to a service and submit, using a payment module, payment for the subscription. The school or institution may register and set up administration accounts and provide information for a database of students using the service. After the school account has set up an institution account, the parents and teachers may register and start utilizing the system. Each account may be registered by providing information such as first name, last name, contact information (email address, phone number, home address, etc.), a username, a password, an age, an associated school or institution, and a location (which could be retrieved using location module on the computing device), and agreeing to terms and conditions. Parents or admin accounts may also create a lock/unlock credential (e.g., a pin number) that is used to end or pause a lockdown period. In addition, parent or admin accounts may submit payment information to pay service charges. FIG. 9 illustrates examples of different accounts and information contained in the accounts. The accounts may each be provided different options or menus tailored to the specific accounts, as shown in FIGS. 7A-9.

Typically, the service is initiated by the Admin/Teacher module generating an assignment or task. The assignment may be generated based on input information received from the teacher. In some embodiments, the assignment is generated based on information in a syllabus for a class. The syllabus may be uploaded to the system and read by admin/teacher module to identify information relating to assignments. The teacher may review and approves the autogenerated assignments. The assignment or task is then sent to the student user module. The assignment includes a date that the assignment is due, at least one task, and any associated information provided by the teacher or admin. For example, the assignment may include a list of approved applications or resources that can be accessed during a lockdown period to complete the assignment.

Upon receipt of an assigned task from an administrator or supervisor account, the assigned task may be displayed on a computing device associated with the user receiving the task, for example, on user device 110. For example, when a student receives an assigned quiz from a teacher, the quiz is displayed on the student's computer or mobile device. The user may be instructed to complete the task within a preset timeframe, where the timeframe may be customized or altered by the administrator or supervisor account. The computing system 100 may initiate a restricted access period on the computing device. The restricted access period may be initiated in response to receiving the task, in response to starting the task, initiated manually by an administrator or supervisor account, or initiated based on some other criteria. Access to application on the computing device may be restricted, locked, or otherwise limited during the restricted access period, as described further herein. The computing system 100 may receive inputs from the user relating to the completion of a task, generate a request for a supervisor or administrator account to approve the task, and end the restricted access period to restore access to applications and features of the computing device when the task is approved. User device 110 may generate a status update for the task and send the status update to at least one of the administrator account and supervisor account—for example, a status update may be generated and transmitted upon starting, stopping, submitting, or otherwise interacting with or altering a task or assignment.

In some embodiments, computing system 100 may receive input from one or more monitoring devices, for example, a webcam or microphone, or capturing input from the user device 110. Received monitoring input may be analyzed to detect one or more parameters and/or monitoring parameters of user device 110. Monitoring of the input may include analyzing video data, audio data, system usage data, and/or other captured inputs to detect an abnormality or non-permitted activity. In some embodiments, analyzing of monitored data may include feeding data into a rule-based system which detects occurrences of malicious activities, for example, by comparing analyzed data to one or more threshold values or other parameters. In response to the analyzing of the monitored data, computing system 100 may lock access to one or more features, generate a notification or alert for an admin/teacher or other associated account, or take other action based on the detecting.

For example, analyzing of the monitoring input may include: checking the user system, such as checking the operating system, browser information, internet speed, and webcam functionality. Monitoring of input may further include user validation using image capture, such as by comparing a verified image of user to an image captured from a webcam of user device.

Monitoring of input may include monitoring and/or detecting one or more video parameters from a video input. Video parameters may include face detection and cell phone detection. Analyzing of video parameters may include face recognition, detecting if the recognized face is within a boundary and visible throughout a time period associated with a task, and determining if one or more prohibited objects are detected in the video during a time is associated with a task. For example, if more than one face is detected, if a face that is not the authorized user is detected, or if a cell phone or book is detected in the video input, computing system 100 may lock access to one or more features, generate a notification for an admin/teacher, submit an associated task as incomplete, or take other action based on the detecting.

Monitoring of input may include detecting or influencing one or more parameters of the user device 110. Influencing user device 100 may include, for example, compelling a program to be in full-screen mode, or influencing the one or more properties of the user device 110 or applications running on the user device 110. Detecting one or more parameters of user device may include shortcut keypress detection, full-screen escape detecting, tab change detection, detection of obfuscation of a camera, and head-pose detection. In some embodiments, detecting may include a usage analysis of the user device or one or more applications or functions of the user device. The usage analysis may include detecting browser and system usage, such as detecting instances when full screen mode is exited, when multiple tabs are opened, when a window is minimized, when certain keys are pressed, or any other measurable information obtained from a monitored system.

Agency device 118 and institution device 116 may act as administrator devices for administrator accounts and supervisor accounts for user device 110 to perform one or more functions to interact with client or user devices. For example, an administrator device may create one or more restrictions that restrict access or lock access to one or more functions normally available on user device. Administrator devices may white-list or permit one or more features that are made accessible even when a restriction is in place, such as permitting features of certain applications, permitting communications with one or more designated accounts or phone numbers, or allowing access to certain websites. For example, user account may still send a communication to an emergency contact during the restricted access period, or retrieve a list of supervisor approved contacts and send a communication to a supervisor approved contact during the restricted access period.

Restrictions during the restricted access period may include, for example, hiding or blocking notifications from non-permitted applications, hiding call notifications from any non-permitted phone number or source, displaying a warning pop-up and prohibiting access to an application of the user device.

Administrator devices may also interact with the client or user device by, for example, assign unique and customizable examination codes, assign one or more online forms or questionnaires, assign customized time durations to one or more tasks or assignments, receive results from one or more assignments. Assignments may be electronic assignments that are completed by inputting information into a computing device associated with the user, e.g. user device 110. Received results from one or more assignments may include receiving a name, email identifier, and one or more monitoring scores. The monitoring scores may include, for example, key press detections, face detections, full screen trigger events, tab change detections, and one or more images of the assignment taker.

Administrator devices may also control user or client devices in one or more other ways on a continuous basis through one or more restrictions applied during the restricted access period. For example, if administrator device has assigned a task to a user, access to one or more applications on the user advice may be restricted or locked until submission of task completion is received and/or verified by administrator device. Restricted applications may include, for example, restricting access from games, non-emergency calls, and/or one or more features of web-browsers.

Restrictions imposed by administrator device on a user or client device may be triggered and removed automatically, for example, when a task is assigned to the user or completed by the user, or may be triggered or removed manually through the administrator device. Administrator device may control or restrict only associated accounts—for example, a teacher may only control user devices associated with their classroom, or a parent may only control user devices associated with their children. Restrictions may be triggered and removed through integration with third-party software, for example, homework assignments may be tracked and monitored through a school portal to automatically trigger and remove restrictions on a user. Restrictions may be triggered or removed upon expiration of one or more time periods associated with a task.

In some embodiments, restriction of a user or client device may include an automatic alert function. Automatic alert function may detect when a user attempts to bypass a restriction, such as by switching off a restricted device, accessing one or more restricted applications, exiting the task without completing the task, or otherwise bypassing a restriction or deviating from permitted content. Based on the detecting, the automatic alert function may log associated activity, transmit the logged activity and user-related identifying information (such as username, login information, name, student number, or other information capable of identifying an associated user account) to an administrator device, and may automatically submit the assignment and record an unfinished or incomplete status associated with the task.

In some embodiments, the above described restricted access period may be implemented by a lock module for restricting applications on a computing device, an assignment module, and an alert module. The assignment module may receive an assignment from an administrator or supervisor account, including at least one task to be completed by a user associated with the computing device and a deadline. The assignment module may receive inputs from the user to complete the at least one task, and the assignment module may update the status of an assignment based on user input, for example, when a user starts, stops, exits, submits, or otherwise interacts with the assignment The alert module may provide an alert to the user on the user computing device, the alert may include the at least one task to be completed by the user, the deadline, and a timeframe for a lockdown period (e.g., the restricted access period). The lock module may initiate the lockdown period, wherein the user is restricted from accessing applications on the user computing device during the lockdown period, and end the lockdown period when the assignment is recorded as complete by the assignment module. In some embodiments, the assignment module is configured to receive approval of a completed assignment from a supervisor account, and the lock module does not end the lockdown period until the approval is received.

An alert or notification is provided to the student and to associated accounts, e.g., parents or guardians. For example, FIG. 9 illustrates a wire diagram of an application for sending notifications and managing tasks. The alert or notification includes the assignment data and any associated information. At the student user module, a secure assignment tracking platform initiates a lock request using a lock system when the assignment data is received.

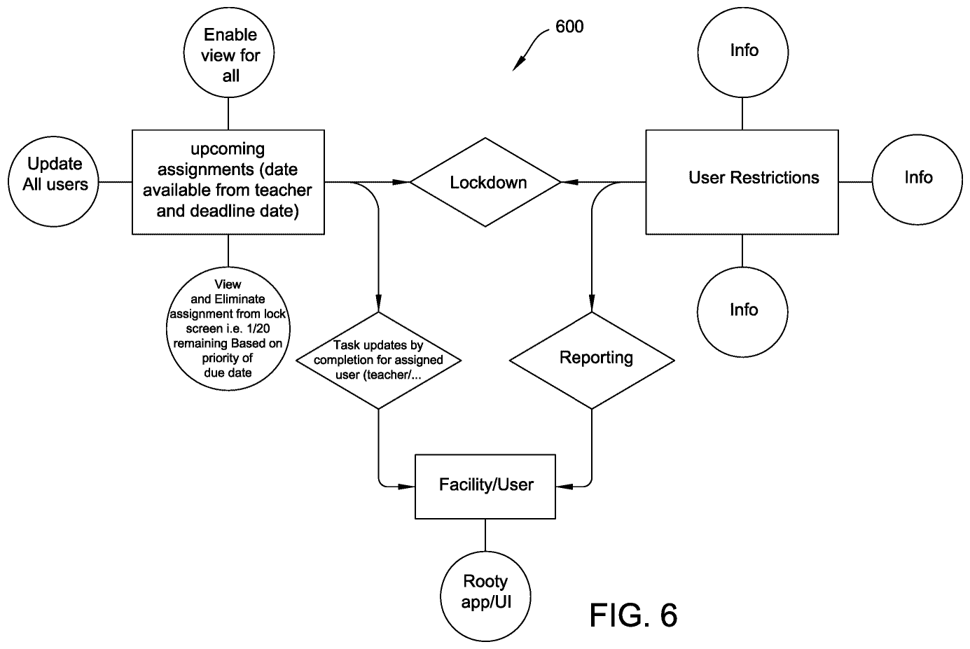

FIG. 6 illustrates a flow diagram of an example lock system 600 for a user computing device of the task management system illustrated in FIG. 5A and FIG. 5B. The lock system 600 restricts access to applications on the students device other than authorized applications listed in the assignment data or a parent approved list.

Users of the task management system 500 may download and/otherwise access the lock system 600 on a personal computing device. Suitably, the student or user downloads a program of lock system 600 on two or more mobile computing devices (e.g., a smart phone, a tablet, a gaming device, and any other system) and registers each of the devices by providing an identification and network address for each device. In the example, lock system 600 runs as a background application. Lock system 600 routinely retrieves the status of tasks and a current date and time. In addition, the lock system compares the status and the date and time to a deadline to see if the date is within a designated period and the status is incomplete. If the status is incomplete for the designated period, the lock system 600 records the incomplete status and initiates the lockdown period. The lock system 600 automatically synchronizes across all of the computing devices that are registered to a user and sends push notifications to the devices.

The lock system 600 may provide a warning to the student and/or teacher of the upcoming lockdown period and enable the student complete or close any activities that would be restricted during the lockdown period. The parent may have capability to override or delay the lockdown period.

The student completes any tasks included in the assignment and submits the assignment for approval. In the example, the parents may approve the completed assignment before the lockdown period is ended by the lock system 600. The status of the task is recorded as completed and a notification is sent to the teacher.

An alert or reminder may be sent to the student and/or parent account if the assignment is not completed by the due date or a prescribed period before the due date. In some examples, the lock down period is only initiated if the assignment has not been completed within a prescribed period before the due date. For example, the lock system illustrated in FIG. 5A and FIG. 5B receives an assignment, records the due date, and then provides an alert(s) to the student and parent at a designated time (e.g., at least 48 hours, at least 24 hours, and/or at least 1 hour) before the deadline. For example, the system provides a notification which may include a splash screen and warns the student that a lockdown period is approaching if the assignment is not completed. After receiving the alert, the student may be able to save and exit any applications before the lockdown period commences.

In the example, users cannot access the unlock/lock feature on any device that is registered to the student. The unlock/lock feature is only accessible using a parent/supervisor or teacher/admin account on computing device that is not registered to the student.

The task management system 500 includes a communication module that enables communication (e.g., chat functions) between users. For example, the student may send a communication in real-time requesting unlocking of an associated device.

The task management system 500 and the lock system 600 can be used for any tasks. For example, parents may use the task management system 500 and the lock system 600 for household chores. The users/students may be locked out of devices if chores are not completed within a set time period.

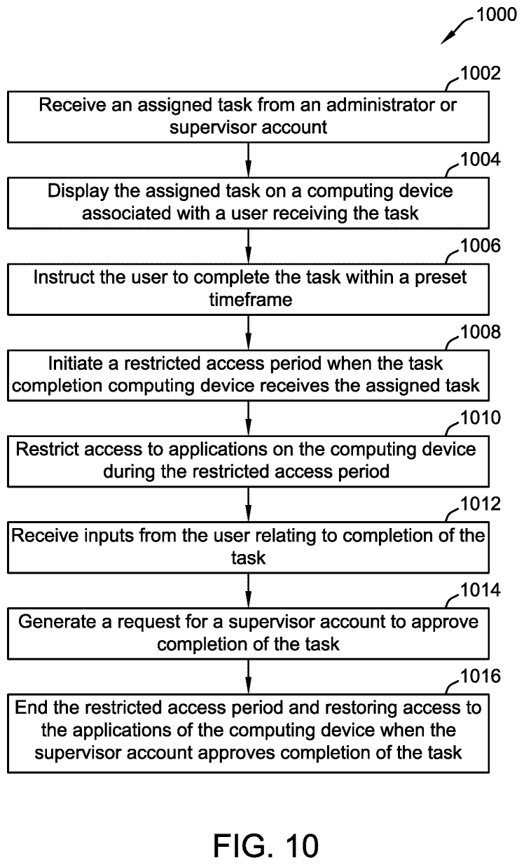

FIG. 10 is a flowchart showing an example method for completing task and providing notifications. Method may include receiving 1002 an assigned task from an administrator or supervisor account. Method may include displaying 1004 the assigned task on a computing device associated with a user receiving the task. Method may include instructing 1006 the user to complete the task within a preset timeframe. Method may include initiating 1008 a restricted access period when the task completion computing device receives the assigned task. Method may include restricting 1010 access to applications on the computing device during the restricted access period. Method may include receiving 1012 inputs from the user relating to completion of the task. Method may include generating 1014 a request for a supervisor account to approve completion of the task. Method may include ending 1016 the restricted access period and restoring access to the applications on the computing device when the supervisor account approves completion of the task.

In some embodiments, the method includes retrieving a list of supervisor approved contacts and sending a communication to a supervisor approved contact during the restricted access period.

In some embodiments, the method includes blocking notifications from applications on the computing device during the restricted access period.

In some embodiments, the method includes monitoring one or more parameters of the user device; wherein the one or more parameters include one or more video parameters; detecting one or more objects based on the video parameters; and generating a notification for the supervisor account based on the detecting.

Accordingly, the described systems facilitate enhanced tracking and monitoring of tasks. In addition, the systems provide real-time notifications regarding status of tasks. Moreover, the system provide incentives to the users to complete tasks so that the users can avoid or end a lockdown period. In addition, the systems facilitate completion of tasks and provide improved performance of the computing device itself because the lock system restricts applications or software that are not necessary to completion of a task and may distract a user and/or utilize memory or processing speed that would slow down the completion of the task.

### Application and User Interface

In an example, system 100 includes an application with a user interface that is accessible on personal computing devices, e.g., client device 108a, client device 108b, user device 110, and client device 118. The user interface receives inputs from users and/or outputs information to users. For example, the user interface includes a screen for displaying messages to the user, an input device for receiving user inputs, and one or more output devices such as speakers, lights, or haptic generators for alerting users.

The user interface allows the user to establish a new user account. For example, the user account may include a username and password. The user may also input verification information and/or the enrollment data. After verifying the user, system 100 may access the enrollment data from the database and associate the relevant enrollment data with the new user account.

The user interface provides the alerts to the users based on the enrollment data and the action items that have been identified as relevant for the enrollment data. The alerts may include messages explaining the action items, images associated with the action items, visual or audio signals, and/or any other suitable alerts.

The user may receive the alert and access the user interface to obtain additional information.

Suitably, the user interface will facilitate the users performing actions related to the alert. For example, the user interface, based on a user input, will call a telephone number for an emergency service related to the alert and/or initiate a request for emergency services based on the alert.

In addition, while using the user interface, the application may hide push notifications from other applications and incoming calls from phone numbers. The hidden notifications and/or phone calls may be based on user preferences, for example, parental controls selected by guardians associated with the user.

The user interface for notification system includes a locking function that inhibits from switching out of the user interface and/or accessing other applications while using the interface. For example, when a user tries to access another application, the user interface may provide a pop-up warning or notification stating that a user cannot switch to another application until a task such as an assignment is completed. The user will acknowledge or click on the warning and then be redirected to the required task to complete. In addition, system 100 may record when the user attempts to deviate to external applications, access websites or information unrelated or unauthorized for the task, and/or power off the device in an assignment log. Additionally or alternatively, system 100 may submit or save the assignment with an unfinished status. The user may have an opportunity to complete the assignment which can be marked as overdue when they return to the appropriate user interface section.

### Integration and API Information

Referring to FIG. 1, system 100 is configured to integrate with existing, new, and/or developing systems. For example, system 100 provides an application programming interface (API) that provides communication and integration between databases and personal computing devices and customer facing software. For example, system 100 can be used with any service that utilizes notifications and/or record keeping, including but not limited to education systems, government agencies, emergency services, and subscription companies. System 100 is compatible with many current APIs from different suppliers and provides a modular solution. For example, system 100 utilizes coding that transforms information from different APIs into a simple, single format that provides a standardized user experience across different institutions.

Accordingly, system 100 can collect information from databases and sources of information based on the industry or institution utilizing system 100. For example, in some embodiments, system 100 accesses information on public video cameras to identify relevant people and other data. Accordingly, system 100 can provide alerts based on people identified in cameras and locations associated with the cameras. System 100 can collect and/or store data sets that are cultivated for specific groups of users. For example, system 100 has data sets for institutions or agencies such as schools, healthcare systems, and police forces.

System 100 sends alerts or notifications to any parties associated with the institution utilizing system 100. For example, notifications are sent to officials associated with an agency, members of an organization, customers, and/or anyone else associated with an institution.

### EXAMPLES

In a first example, a task management computing device includes a processor in communication with a memory. The processor is programmed to receive an assigned task from an administrator account; display the assigned task on a computing device associated with the user receiving the task; instruct the user to complete the task within a preset timeframe; initiate a restricted access period when the task management computing device receives the assigned task; restrict access to applications on the computing device during the restricted access period, wherein the restricted applications include games, social media, and internet applications; receive inputs from the user relating to completion of the task; generate a request for a supervisor account to approve completion of the task; and end the restricted access period and restore access to the applications on the computing device if the supervisor account approves completion of the task.

In a second example, a task management computing device in accordance with example 1, wherein the processor is further programmed to send a communication to an emergency contact during the restricted access period.

In a third example, a task management computing device in accordance with example 1, wherein the processor is further programmed to retrieve a list of supervisor approved contacts and send a communication to a supervisor approved contact during the restricted access period.

In a fourth example, a task management computing device in accordance with example 1, wherein the task comprises an electronic assignment that is completed by inputting information into the computing device associated with the user.

In a fifth example, a task management computing device in accordance with example 1, wherein the processor is further programmed to block notifications from applications on the computing device during the restricted access period.

In a sixth example, a task management computing device in accordance with example 1, wherein the processor is further programmed generate a status update for the task and send the status update to at least one of the administrator account and the supervisor account.

In a seventh example, a task management computing device in accordance with example 1, wherein the processor is further programmed to record an incomplete status of the task when the user attempts to exit the task without completing the task.

In another example, a lock system for restricting applications on computing device comprises an assignment module that receives an assignment from an administrator account. The assignment includes at least one task to be completed by a user associated with the computing device and a deadline. The assignment module is configured to receive inputs from the user to complete the at least one task, wherein the assignment module updates the status of the assignment when the user completes the task. The lock system also includes an alert module that provides an alert to the user on the user computing device. The alert includes the at least one task to be completed by the user, the deadline, and a timeframe for a lockdown period. The lock system further includes a lock module configured to initiate the lockdown period, and end the lockdown period when the assignment is recorded as complete by the assignment module.

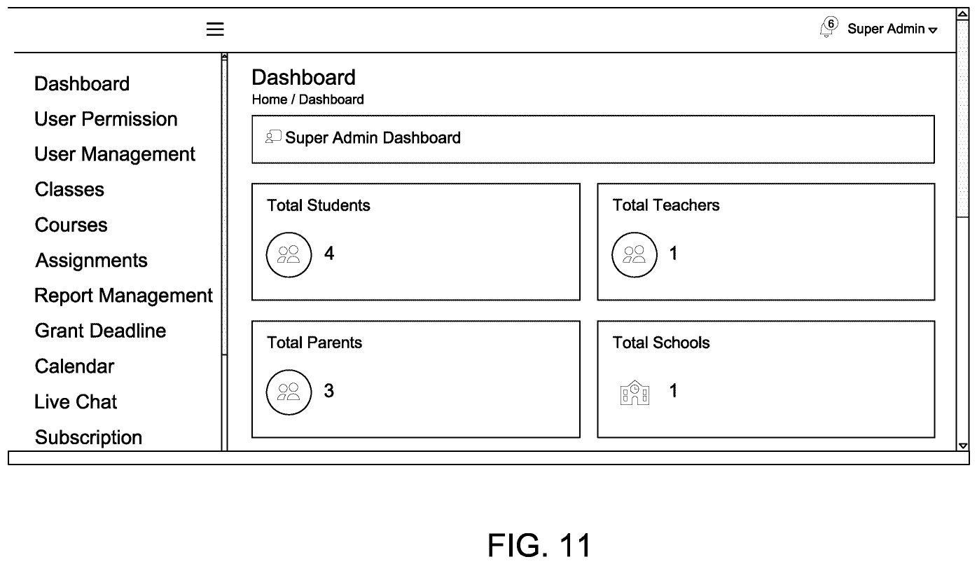

FIG. 11 illustrates an example dashboard user interface of a system and method for sending notifications and completing tasks, showing an administrator dashboard display number of enrolled students, teachers, parents, and schools. The Dashboard provides summary information for the system and can be where a default landing page when the system is initiated. In addition, the user may receive notifications on the Dashboard.

The user interface includes a menu for selecting functions of the system. For example, the menu includes options for “Dashboard”, “User Permission”, “Users Management”, “Classes”, “Courses”, “Assignments”, “Report Management”, “Grant Deadline”, “Calendar”, “Live Chat”, and “Subscription”. The user may select one or more of the options to navigate to a page, activate/deactivate an option, and/or view additional selections. The options may include drop down menus.

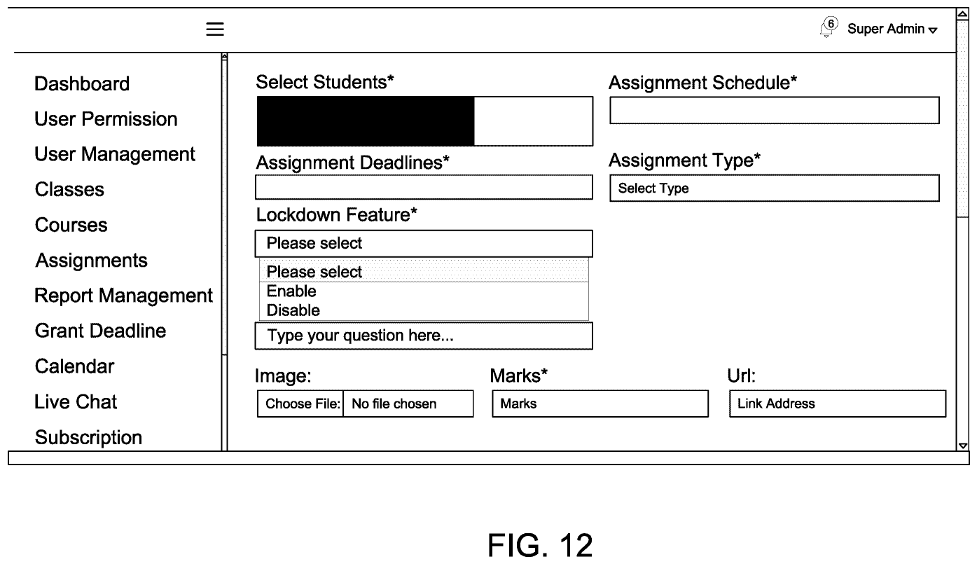

FIG. 12 illustrates an example user interface of a system and method for sending notifications and completing tasks showing an administrator view, showing a lockdown enablement feature for restricted access mode. For example, FIG. 12 displays a page for creating or editing assignments. The user selects students, assignment schedule, assignment type, images, marks, webpages, and/or any other parameters to associate with the assignment. In addition, the user is able to enable or disable the lockdown feature for the assignment on the illustrated feature. The Lockdown option includes a dropdown menu for selecting “Disable” or “Enable”. When “Enable” is selected, the lockdown system described herein is activated for the assignment and, when the assignment is sent to the selected students, may lockdown the student's devices based on the other selected parameters (e.g., due date, parent approval, etc.). In embodiments, the Assignment page may be used to setup or edit assignments before or after the assignments are sent to students.

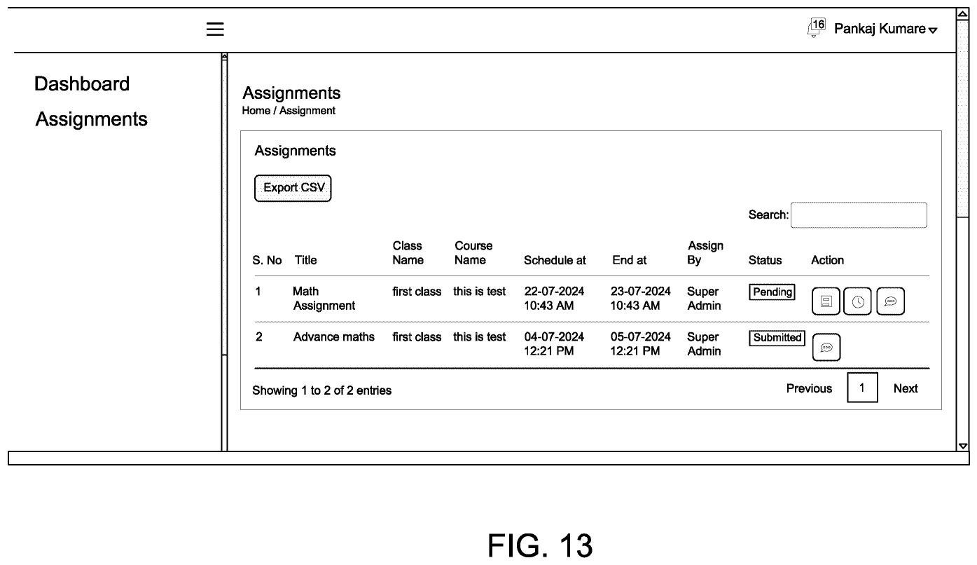

FIG. 13 illustrates an example user interface of a system and method for sending notifications and completing tasks showing an assignment view, showing a list of scheduled assignments including information such as scheduling time, who the task was assignment by, and one or more buttons for interacting with an assignment. The assignment page includes a summary of all assignments associated with the account and a status of each assignment. In addition, the assignment page can include links to access an assignment and/or add comments on the assignment.

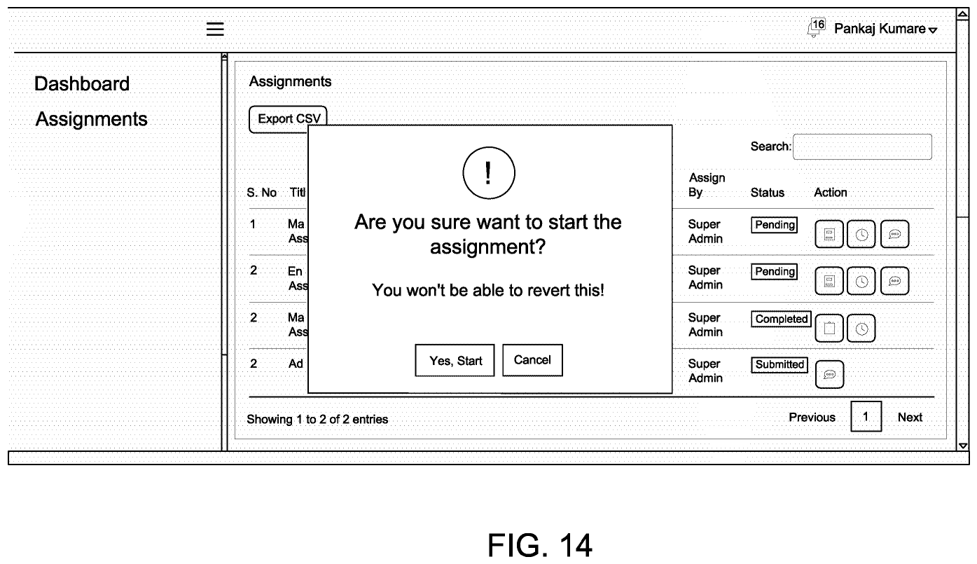

FIG. 14 illustrates an example user interface of a system and method for sending notifications and completing tasks showing an assignment start display, showing a notification displayed to a user before an assignment is started. For example, the user selects the assignment and the assignment question is asked to notify the user that they are accessing the assignment and starting any timetables or processes for the assignment. If the user selects start, the lockdown system associated with the assignment may be activated on their device. For example, the device may be locked until the assignment is completed and/or approved.

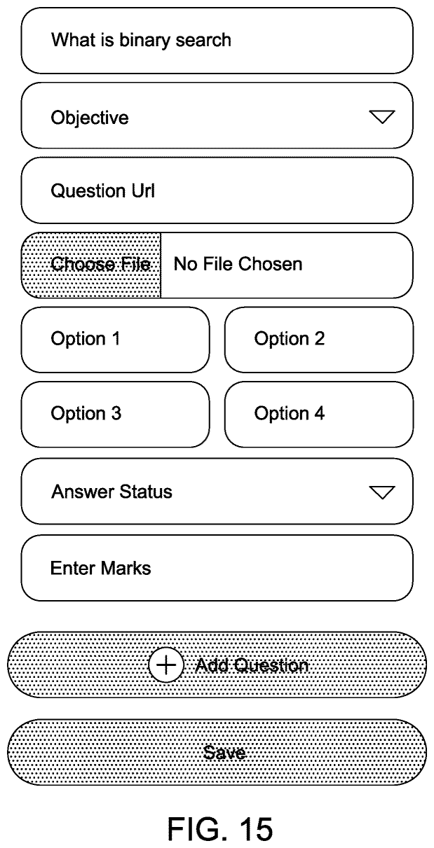

FIG. 15 illustrates an example user interface of a system and method for sending notifications and completing tasks, for example, showing an assignment question being created by an administrator. The user may use the system to create a series of questions and/or tasks that together compose an assignment.

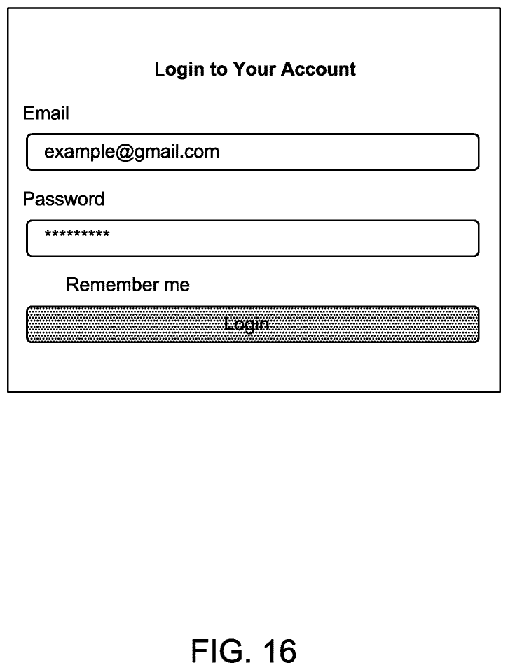

FIG. 16 illustrates an example user interface of a system and method for sending notifications and completing tasks showing a login screen. The login screen is used to access an account associated with the system. For example, the accounts may be a creator account, a student or assignee account, a parent or supervisor account, and/or any suitable account. The user enters credentials to access the appropriate account.

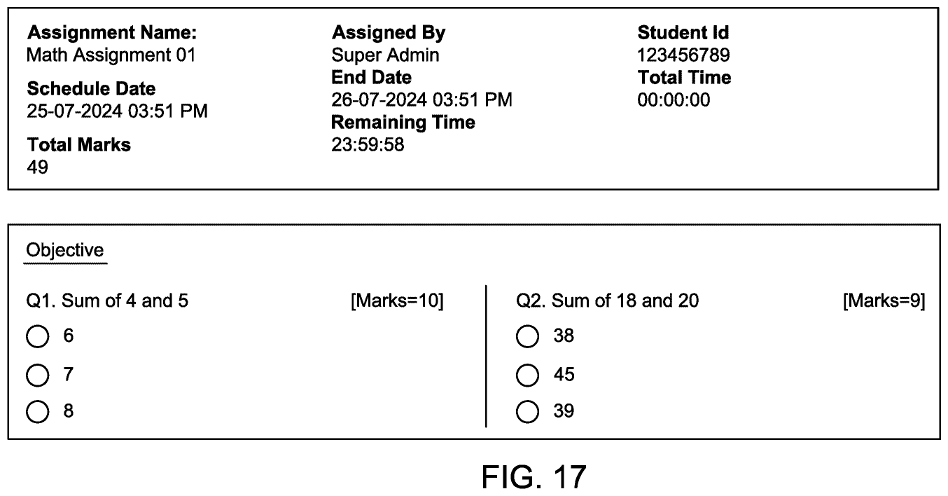

FIG. 17 illustrates an example of user interface including an assignment to be completed by a user. The assignment includes parameters entered by the creator and data for the assignments such as remaining time. The assignment also includes data on the user that the assignment is associated with. The user completes questions in the assignment and then may submit the assignment for review.

### Function

An example of a lock system such as lock system 600 includes the following functions:
1. Parent User: A parent user can register students. Then students can setup their account using an email identification.

Parent registration includes the following fields to receive user inputs:
1.1 First Name
1.2 Last Name
1.3 Email Address
1.4 Username
1.5 Password
1.6 Confirm Password
1.7 Card details (The card be used for the membership payment, the membership fees will auto deduct after 3 days from the same card).
1.8 Credit Card
1.9 Mailing address
1.10 Location (Application fetches the location of the users using location systems on the computing device)
1.11 Agree to terms and conditions and user agreement (e.g., user selects “Yes I agree”)

After submitting the form, user will be required to validate the email address prior to initial login.
2 Student User

Student User is registered by an associated parent account and payments are made from the parent account. The student user and parent are related to each other by linking information. The student user form has the following fields:
2.1 First Name
2.2 Last Name
2.3 Email Address
2.4 Username
2.5 Password
2.6 Confirm Password
2.7 Age
2.8 School (For example, there is a dropdown menu of available schools, a user can select a school from the list, the dropdown menu may include an option “to fill the school name if it is not in the list”)
2.9 Location (Application fetches the location of the users)
2.10 Agree to terms and conditions and user agreement (click on “Yes I agree”)

After submitting the form, user is required to validate the email address prior to initial login.
3 School User

School User Registration. A school user can register a parent and the parent can register their Student User as well as a new user by using an email identification. The school user form includes the following fields:
3.1 First Name
3.2 Last Name
3.3 Email Address
3.4 Username
3.5 Password
3.6 Confirm Password
3.7 Card details (if payment is required) School will need to enter their Credit Card or alternative payment details
3.8 Credit Card
3.9 Location (Application can fetch the location of the users)
3.10 Agree to terms and conditions and user agreement (click on “Yes I agree”)

After submitting the form, a user is required to validate the email address prior to initial login.
4 Teacher User

Teacher is able to create an account and assign homework/tasks. The following fields are provided for teacher registration:
4.1 First Name
4.2 Last Name
4.3 Email Address
4.4 Username
4.5 Password
4.6 Confirm Password
4.7 Payment details (Payment info can be populated from information stored for the associated school, teachers do not need to fill this in)
4.8 Credit Card
4.9 Location (Application will fetch the location of the users)
4.10 Agree to terms and conditions and user agreement (click on “Yes I agree”)

After submitting the form, user may be required to validate the email address prior to initial login.
5 Teacher Panel has the following modules:
5.1 Dashboard
5.2 Homework Assignment
5.3 Notifications
5.4 Gradebook
5.5 Communication
5.6 Resources and Materials
5.7 Analytics and Reports
5.8 Support
5.9 Account Management
6 Admin User:

Admin has the following modules at the dashboard and manages the following features:
6.1 Count of the users
6.2 Count of the assigned assignment
6.3 Count of the scheduled assignment
6.4 Count of the Pending Assignment
6.5 Graphs
6.6 Assignment in Table view
6.7 Attendance count
6.8 On-screen Pop-Up capability
6.8.1 Setting for full screen notification pop up at student app.
6.9 Live Homework Assignments Streaming
6.9.1 Lock system during live homework streaming
6.10 App Game Restrictions
6.10.1 Game Lock
6.11 Unauthorized Website Restriction
6.11.1 Restricts student users from accessing unauthorized websites while they are completing their homework.
6.12 Parental Control
6.12.1 Display notifications on the screen for a limited time, specifically targeting students during assignments and exams. It prevents student accounts from switching screens or accessing apps while assignments are ongoing.
6.13 Auto Block Feature
6.13.1 Automatic Activation for Homework
6.13.2 The lock system will automatically activate when a student accesses their assigned homework, blocking phone, app, and website access until the assignment is submitted in the teacher portal.
6.13.3 Parental Manual Activation
6.13.3.1 Parents can manually activate the lock system by assigning custom tasks on the child's portal, and triggering a popup on the student's screen if assignments are pending.
6.13.4 Teacher-initiated Activation
6.13.4.1 Teachers can initiate a popup on students' screens when needed, for attention-grabbing, class presentations, or detention purposes.
7 Dashboard for Student Users

After Login to the Web app, users can view the following sub-sections:
7.1 Account setting
7.1.1 General setting
7.1.2 Privacy & Security setting
7.1.3 Primary and Secondary Phone Number
7.2 My profile
7.2.1 Create profile
7.2.2 Edit and Update profile
7.2.3 Deactivate or delete the profile
7.3 My profile
7.3.1 Enabling push notifications for Student User regarding the latest activity throughout the application.
8 Dashboard for Parent Users
8.1 Account setting
8.1.1 General setting (User can set the general setting of the application)
8.1.2 Privacy & Security setting
8.1.3 Primary and Secondary Phone Number
8.1.4 In App Permissions Parent users can elect to receive push notifications regarding the activity of their Student User (e.g., if the Student User is submitting the assignment then a notification will be sent to the parent's user).
8.2 My profile
8.2.1 Create profile
8.2.2 Edit and Update profile
8.2.3 Deactivate or delete the profile
8.3 My Subscription

This section displays the subscription status to the Parent User. For example, there may be a trial period (e.g., 3 days) for the user.
8.4 Membership Renewal

Parent can select for Auto Renewal of their account and subscription fees are auto-deducted from parent's payment information. Can pay using an online payment system, bank account, and/or credit card. Notifications regarding subscription status may be sent to the user.

In the example, parent users purchase the membership. Student users do not have access to payment or subscription information.
9 Dashboard for School Users/Teachers
9.1 Account setting
9.1.1 General setting
9.1.2 Privacy & Security setting
9.1.3 Primary and Secondary Phone Number
9.1.4 In App Permissions—Teacher users can elect to receive push notifications regarding the activity of their Student User (e.g., if an associated Student User has started the assignment or completed the assignment).
9.2 My profile
9.2.1 View profile—Users

(Parents/Teachers/Admin/Students/Customer/Patients) can set/edit the profile from this section where they can view the details entered during sign up like name, address, email ID, contact telephone number, etc.
9.2.2 Edit profile—Users

(Parents/Teachers/Admin/Students/Customer/Patients) can edit the above parameters from this section.
9.2.3 Password—Ability to set/edit password from this section.
9.3 My Subscription

This section displays the subscription status to the School User. For example, there is a trial period of 3 days for the user, after 3 days of trial application they receive a notification for the membership purchase. Unless they opt out, the application will deduct the membership amount from the card which user has been added at the time of the registration.
9.4 Membership Renewal For example, there are monthly membership fees for the users.

School can apply for Auto Renewal of their account, in that case monthly subscription fees will auto-deduct from school's credit card that they have added at the time of registration. In case, school will not apply for Auto Renew Membership, then they can renew their membership by submitting payment using, for example, an online payment system.

System will send email notification to school according to renewal date. If they do not select auto renewal, once membership plan is nearing an end, the member is notified that they need to renew.
10 Dashboard
10.1 Push notifications
10.1.1 School receives notifications of their Student User's activity throughout the application. App may have permission to send the notifications to the users for the user's activity.
10.2 Register Parents/Teachers/Students
10.2.1 School can register teachers, students and parents
10.3 Module permissions for teachers
10.3.1 School can give permission to teachers to specific modules
10.4 Announcement and Notification System
10.4.1 Send announcements or notifications to teachers, students, Parents or specific classes
10.5 Settings:
10.5.1 Change Password
10.5.2 Generate Login Credentials for users
10.6 Grading:
10.6.1 View grading as per assignment submitted by students
10.7 Reports:
10.7.1 Able to see all the list of the assignments with status
10.7.2 Able to see the grades of the students
10.7.3 Able to see the analytics
10.8 Calendar/Schedule
10.8.1 Able to see the scheduled assignments
10.9 Grant Deadline Extensions
10.9.1 Grant deadline extensions on a case-by-case basis.
10.10 Assigned class:
10.10.1 List of assigned classes
10.11 Assignment Screen:
10.11.1 Class Filter
10.11.2 List of Assignments
10.11.3 Scheduled Assignments
10.11.4 Pending Assignments
11 Dashboard for School Users

After Login to the app, School users can view below sub-sections:
11.1 Account setting
11.1.1 General setting
11.1.2 Privacy & Security setting
11.1.3 Primary and Secondary Phone Number
11.1.4 In App Permissions School users can elect to receive push notifications regarding the activity of their Student User like if their Student User have posted new videos, commented on videos, or did not participate in caring (Images and video)
11.2 My profile
11.2.1 View profile—Customer/Patients have the ability to set/edit the profile from this section where they can view the details entered during sign up like name, address, email ID, telephone number, etc.
11.2.2 Edit profile—Customer/Patients will have the ability to edit the above parameters from this section.
11.2.3 Password—Ability to set/edit password from this section.
11.3 My Subscription—This section will display the subscription status to the School User. For example, there is a trial period of 3 days for the user and they will have all the benefits within the trial period, after 3 days of trial the system will provide a notification for the membership purchase. The system will deduct the membership amount from the card which user has been added at the time of the registration.
11.4 Membership Renewal—School can apply for Auto Renewal of their account, in that case monthly subscription fees will auto-deduct from school's credit card that they have added at the time of registration. In case school will not apply for Auto Renew Membership, then they can renew their membership by paying the app by using online payment services. System will send email notification to school according to renewal date. If they don't select auto renewal, once membership plan is nearing an end, the member should be notified that they need to renew.
11.5 Push notifications—School receives notifications of their Student User' activity throughout the application. App will have permission to send the notifications to the users for the user's activity.
11.6 Register Parents/Teachers/Students
11.6.1 School can register teachers, students and parents
11.7 Module permissions for teachers
11.7.1 School can give permission to teachers to specific modules
11.8 Announcement and Notification System
11.8.1 Send announcements or notifications to teachers, students, Parents or specific classes
11.9 Settings:
11.9.1 Change Password
11.9.2 Generate Login Credentials for users
11.10 Grading:
11.10.1 View grading as per assignment submitted by students
11.11 Reports:
11.11.1 Able to see all the list of the assignments with status
11.11.2 Able to see the grades of the students
11.11.3 Able to see the analytics
11.12 Calendar/Schedule
11.12.1 Able to see the scheduled assignments
11.13 Grant Deadline Extensions
11.13.1 Grant deadline extensions on a case-by-case basis.
11.14 Assigned class:
11.14.1 List of assigned classes
11.15 Assignment Screen:
11.15.1 Class Filter
11.15.2 List of Assignments
11.15.3 Scheduled Assignments
11.15.4 Pending Assignments
12 Admin Panel which will have below functionalities:

After Login to the portal, admin can view below sub-sections:
12.1 User Management

Admin has the controls over the users, Admin can add, edit, delete the profile of the user.
12.2 Subscription Management
12.2.1 Admin can manage the subscription of the users, for example, the admin will have the list of users of “Renewed subscription” “Expiring subscriptions” list of “Newly purchased”.
12.2.2 Admin can manage a refund and termination of the subscription.
12.2.3 Invoice (email only)
12.2.4 Admin is able to temporarily block a subscription if a user is violating a policy, for example.
12.3 Content management
12.3.1 Admin is able to manage the content and format of the system. For example, Admin can select information that is provided to users.
12.3.2 Admin is able to manage the categories, for example, Admin can add, edit and delete the categories of the system.
12.3.3 Admin is able to view the badges, add, edit and delete the badges of the user if required.
12.4 Report and Block management
12.4.1 Admin receives a reported user list and on the basis of that report, admin can block a user on the list.
12.4.2 Admin can temporarily suspend the account of the user or permanently delete the account of the user.
12.5 Category Management—Users are grouped into categories
12.5.1 Admin can edit categories.
12.5.2 Admin will be able to add the Categories.
12.5.3 Admin will be able to delete the Categories.
12.6 Teacher Management:
12.6.1 Add—Edit
12.6.2 Listing View Details
12.6.3 Delete
12.6.4 Assign Teacher to School and class
12.7 Student Management:
12.7.1 Add—Edit
12.7.2 Listing View Details
12.7.3 Delete
12.7.4 Assign Students to Class and School
12.8 Parent Management:
12.8.1 Add—Edit
12.8.2 Listing View Details of Parents and Associated Students
12.8.3 Delete
12.9 Role/Permission Management
12.9.1 Roles creation
12.9.2 Module wise permission access
12.10 School Management:
12.10.1 Add—Edit Schools
12.10.2 School data will be fetched from a website or database
12.10.3 Delete School
12.10.4 Listing of the Schools
12.11 Class Management:
12.11.1 Add-Edit
12.11.2 Delete Class
12.11.3 Listing of Classes
12.12 Course Management:
12.12.1 Fetch the courses details from online course management program
12.12.2 Listing of the Courses arranged by class
12.13 Assignment Management:
12.13.1 Fetch the Assignments from online course management program
12.13.2 Assignments list
12.13.3 Create and manage assignments based on syllabus and user requests.
12.13.4 Set assignment deadlines, open and close assignments.
12.13.5 Assign assignments to specific courses and classes.
12.13.6 View and manage assignment details, including due dates, completion dates, and grades.
12.14 Grading Management:
12.14.1 Fetch the Assignments from online course management program
12.14.2 Assignments list
12.14.3 Create and manage assignments based on syllabus and user requests.
12.14.4 Set assignment deadlines, open and close assignments.
12.14.5 Assign assignments to specific courses and classes.
12.14.6 View and manage assignment details, including due dates, completion dates, and grades.
12.15 Report Management:
12.15.1 Ability to generate the reports
12.15.2 Assignments Completion Reports
12.15.3 Pending Assignment Reports
12.15.4 Students Grading reports
12.16 Sharing Additional Resources:
12.16.1 Ability to share additional resources, such as reading materials or reference materials
12.17 Notification:
12.17.1 Push Notification are sent to the users
12.18 Subscription Management:
12.18.1 Plans are selected by user
12.19 Settings:
12.19.1 Notification Preferences
12.19.2 Email Preferences
12.19.3 Disabling the social media access, permission to submit the assignment after parents approval
12.20 Live Chat Management:
12.20.1 Student can seek help from Teacher with the help of live chat related to the assignment
13 List of Screens in Parent/Student App 13.1 Splash Screen
13.2 Registration Screen
13.3 Login Screen
13.4 Dashboards for Student User& Parents
13.5 Membership Screen
13.6 Payment Screen
13.7 Notification screen
13.8 About us
13.9 How it works
13.10 Setting screen
13.11 My profile Screen
13.12 Change Password Screen
13.13 Forgot Password Screen
13.14 Assignment Screen
13.15 Assignment Listing Screen
13.16 Grades Screen

### Application

Examples described herein have application in a wide variety of industries. For example, the described systems and methods may be used in any industries that utilize notifications and/or tasks assigned to users. Accordingly, the systems and methods may utilize data sets that are collected and/or correlated for specific applications or groups such as education institution, healthcare facilities and services, police force, retail establishments, and/or emergency services. The systems provide real-time interconnection to response units attached to a centralized unit and/or a dispersed communication node. The platform is modular and includes coding that interface with API's to generate a simple user experience. In addition, examples include a node that locks the remote computing device to provide a notification and/or a task to be completed while the computing device is in the locked mode.

The platform can provide a subscription style service where users pay a membership fee to join and/or access the application. In addition, the platform can provide documentation of use such as identifying products and services that are being provided and provide related information. The platform can provide feedback and enhanced information in real-time based on user experiences with the task and/or notifications. For example, the platform evaluates data and confirms that storage requirements are met within the platform in real-time. In some examples, the platform identifies objects or peoples via public cameras and sends notifications based at least in part on the identifications in real-time.

For example, the systems may be used in different businesses to monitor and/or report business parameters. For example, businesses of or related to artists or performers (e.g., musicians, actors, comedians, etc.) can use the systems to track the revenue gained from performances, venues, and/or broadcasts (e.g., different streaming services) and enhance the visibility and allocation of proceeds per product/service streamed by contractual rates or other metrics. For example, the performers could upload performances as assignments, tasks, or other documents described herein and utilize the broad reporting functionality.

The described systems have a broad range of uses and may be used, for example, in industries such as the solar industry as in a nonlimiting example a locking or triggering module.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data to facilitate making predictions for subsequent data. Models may be created based upon example inputs to make valid and reliable predictions for novel inputs.

Additionally or alternatively, the machine learning programs may be trained by inputting sample data sets or certain data into the programs, such as images, object statistics and information, audio and/or video records, text, and/or actual true or false values. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, but is not limited to, a fixed (hard) drive, diskette, an optical disk, a magnetic tape, a semiconductor memory, such as read-only memory (ROM), a transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

In one aspect, a system for managing tasks and providing notifications includes a lock system. The lock system restricts access to applications on a user's personal computing device during a lockdown period associated with the tasks or notifications. The lock system ends the lockdown period when the user completes the task or acknowledges the notification.

In another aspect, a task completion module for restricting applications on computing device includes an assignment module that receives an assignment from an administrator account. The assignment module includes at least one task to be completed by a user associated with the computing device and a deadline. The assignment is completed by inputs from the user. The assignment module updates the status of the assignment when the user completes the task. The lock system also includes an alert module that provides an alert to the user on the user computing device. The alert includes the at least one task to be completed by the user, the deadline, and a timeframe for a lockdown period. The task completion module includes a lock system configured to initiate the lockdown period during which the user is restricted from accessing applications on the user computing device during the lockdown period, and end the lockdown period when the assignment is recorded as complete by the assignment module.

In another aspect, a notification computing device includes at least one processor in communication with at least one memory device. The at least one processor is programmed to: receive enrollment data pertaining to a user; associate one or more users of the notification computing platform based on the enrollment data; associate an institution with the user based on the enrollment data; receive, on an ongoing basis, information from the institution; detect an actionable item based on the information received from the educational institution to the student; generate an alert based on the actionable item; and transmit the alert to the student, the one or more users associated with the student, or both.

In another aspect, a task management computing device includes a processor in communication with a memory. The processor is programmed to: receive an assigned task from an administrator account; display the assigned task on a computing device associated with the user receiving the task; instruct the user to complete the task within a preset timeframe; initiate a restricted access period when the task management computing device receives the assigned task; restrict access to applications on the computing device during the restricted access period, wherein the restricted applications include games, social media, and internet applications; receive inputs from the user relating to completion of the task; generate a request for a supervisor account to approve completion of the task; and end the restricted access period and restore access to the applications on the computing device if the supervisor account approves completion of the task.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A task completion computing device comprising a processor in communication with a memory, wherein the processor is programmed to:
receive an assigned task from an administrator or supervisor account;
display the assigned task on a computing device associated with a user receiving the task;
instruct the user to complete the task within a preset timeframe;
initiate a restricted access period when the task completion computing device receives the assigned task;
restrict access to applications on the computing device during the restricted access period, wherein the restricted applications include games, social media, and internet applications;
receive inputs from the user relating to completion of the task;
generate a request for a supervisor account to approve completion of the task; and
end the restricted access period and restore access to the applications on the computing device if the supervisor account approves completion of the task.

2. A task management computing device in accordance with claim 1, wherein the processor is further programmed to send a communication to emergency contact during the restricted access period.

3. A task management computing device in accordance with claim 1, wherein the processor is further programmed to retrieve a list of supervisor approved contacts and send a communication to a supervisor approved contact during the restricted access period.

4. A task management computing device in accordance with claim 1, wherein the task comprises an electronic assignment that is completed by inputting information into the computing device associated with the user.

5. A task management computing device in accordance with claim 1, wherein the processor is further programmed block notifications from applications on the computing device during the restricted access period.

6. A task management computing device in accordance with claim 1, wherein the processor is further programmed generate a status update for the task and send the status update to at least one of the administrator account and the supervisor account.

7. A task management computing device in accordance with claim 1, wherein the processor is further programmed to record an incomplete status of the task when the user attempts to exit the task without completing the task.

8. A notification computing device, the notification computing device comprising at least one processor in communication with at least one memory device, wherein the at least one processor is programmed to:
receive enrollment data pertaining to a user;
associate one or more users of the notification computing platform based on the enrollment data;
associate an institution with the user based on the enrollment data;
receive, on an ongoing basis, information from the institution;
detect an actionable item based on the information received from an administrator, a supervisor, or the users;
generate an alert based on the actionable item; and
transmit the one or more users associated with the institution.

9. The notification computing device of claim 8, wherein a student is one of the one or more users.

10. The notification computing device of claim 9, wherein at least one of the one or more users is a legal guardian of the student.

11. The notification computing device of claim 9, wherein the enrollment data includes one or more of a name, grade, age, school, address, phone number, guardian's names, siblings, and notification preferences.

12. The notification computing device of claim 8, wherein the alert is only transmitted to the user if permitted by a notification preference specified by the user's enrollment data.

13. The notification computing device of claim 8, wherein the alert is only transmitted to the one or more users associated if permitted by a notification preference specified by the user's enrollment data.

14. The notification computing device of claim 8, wherein the actionable item is time sensitive.

15. A method completing tasks and providing notifications implemented by at least one processor in communication with at least one memory, the method comprising:
receiving an assigned task from an administrator or supervisor account;
displaying the assigned task on a computing device associated with a user receiving the task;
instructing the user to complete the task within a preset timeframe;
initiating a restricted access period when the task completion computing device receives the assigned task;
restricting access to applications on the computing device during the restricted access period, wherein the restricted applications include games, social media, and internet applications;
receiving inputs from the user relating to completion of the task;
generating a request for a supervisor account to approve completion of the task; and
ending the restricted access period and restoring access to the applications on the computing device when the supervisor account approves completion of the task.

16. The method in accordance with claim 15, further comprising:
retrieving a list of supervisor approved contacts and sending a communication to a supervisor approved contact during the restricted access period.

17. The method in accordance with claim 15, further comprising:
blocking notifications from applications on the computing device during the restricted access period.

18. The method in accordance with claim 15, further comprising:
monitoring one or more parameters of the user device;
wherein the one or more parameters include one or more video parameters; and
generating a notification for the supervisor account based on the detecting.

19. The method in accordance with claim 18, further comprising:
detecting one or more objects based on the video parameters.

20. The method in accordance with claim 18, wherein the one or more video parameters include at least one of: detection of a face, detection of obfuscation of a camera, or head-pose detection.
